(19) United States
(12) Patent Application Publication
(10) Pub. No.: US 2023/0389702 A1
(43) Pub. Date: Dec. 7, 2023

(54) UNDERMOUNT DRAWER SLIDE

(71) Applicant: Actron Manufacturing, Inc., Corona, CA (US)

(72) Inventor: Jason A. Rechberg, Corona, CA (US)

(21) Appl. No.: 18/452,083

(22) Filed: Aug. 18, 2023

Related U.S. Application Data
(63) Continuation of application No. 17/688,303, filed on Mar. 7, 2022.
Application No. 17/688,303 is a continuation of application No. 16/782,315, filed on Feb. 5, 2020, now abandoned.
(60) Provisional application No. 62/801,349, filed on Feb. 5, 2019.

(51) Int. Cl. A47B 88/493

(52) U.S. Cl. CPC A47B 88/493; A47B 2210/0056

(57) ABSTRACT

A drawer slide including a base member, a roller support, ball bearings and roll pins. The base member a track base and first and second walls. The first and second walls and the track base define a first channel. The first wall has a first race and the second wall has a second race. The roller support is within the first channel. The roller support has first and second side walls and a center section disposed between the first and second side walls. The first and second side walls are disposed adjacent the first and second walls. The center section is disposed adjacent the track base. The first and second side walls have bearing apertures. The center section has roller openings. The ball bearings are disposed the first and second races. The roll pins are in the roller openings in rolling contact with the track base.

### CROSS-REFERENCE TO RELATED APPLICATIONS

This application is a continuation of U.S. application Ser. No. 17/688,303, filed Mar. 7, 2022, which is a continuation of U.S. application Ser. No. 16/782,315, filed Feb. 5, 2020, which claims the benefit of U.S. Application Ser. No. 62/801,349, filed Feb. 5, 2019, the contents of which are expressly incorporated herein by reference.

### STATEMENT RE: FEDERALLY SPONSORED RESEARCH/DEVELOPMENT

Not Applicable

### BACKGROUND

The present invention relates in general to a drawer slide, and more particularly, to a multi-member drawer slide with at least one element milled from a single piece of material configured to be mounted on the underside of a drawer.

Drawer slides in general are well known. More particularly, side mount drawer slides which consist of a rail and a support with rollers are well known. Drawer slides that include multiple, substantially linear, metal slides each sliding within an interior channel of the next successively larger member are also known in the art. By a succession of such metal members, a drawer or an object supported by such members may slide between a first position when the metal members are fully extended from each other and a second position when the metal members are fully retracted and overlapping. Because of this basic structure of metal slides sliding within the interior channel of the next successively larger member, with excessively heavy drawers, side mount drawer slides may bind or wear improperly. Additionally, with heavy drawers, it is difficult to attach the drawer to the drawer slides when using side mount drawer slides.

The prior art drawer slide members make certain accommodations to their sliding and suspension functions. In order to stand up to the forces provided by heavy drawers, prior drawer slides use steel or steel alloy metals and incorporate shorter travel distances, so that the drawer slides do not have to support cantilevered weight placed at a great distance from the structure on which it is placed. Prior art drawer slides may use a rack and pinion arrangement to avoid racking, which is a side to side movement of the drawer when the drawer is in an extended position. To further reduce racking, some drawers use a third drawer slide in an undermount configuration. This third drawer slide adds to the expense and weight of the drawer slide system.

In view of the foregoing, there is a need in the art for an improved drawer slide design.

### BRIEF SUMMARY

According to an aspect of the invention, there is provided a drawer slide. The drawer slide includes a base member having a track portion with a track base and first and second outer walls extending from the track base. The first and second outer walls and the track base define a first channel along a longitudinal axis. The first outer wall has a first outer race, and the second outer wall has a second outer race. The drawer slide further includes a lower roller support slidably disposed within the first channel along the longitudinal axis. The lower roller support has first and second lower inner side walls and a lower center section disposed between the first and second lower inner side walls. The first and second lower inner side walls respectively are disposed adjacent the first and second outer walls of the track portion. The lower center section is disposed adjacent the track base. The first and second lower inner side walls respectively have lower bearing apertures formed there through. The lower center section has lower roller openings formed there through. The drawer slide further includes a first plurality of ball bearings respectively disposed in the lower bearing apertures and the first and second outer races. The drawer slide further includes a first plurality of roll pins respectively disposed orthogonal to the longitudinal axis in the lower roller openings in rolling contact with the track base.

According to various embodiments, the base member may be formed from a singular piece of material. In this regard, the base member may be formed of a single piece of milled metal. The drawer slide is contemplated for use with a drawer and a drawer surround sized and configured to receive the drawer. The track portion may have a mounting hole formed there through for mounting the base member to the drawer surround with a fastener. The base member may have an elongate flange extending along the track portion. The flange may be orthogonally disposed with regard to the track base. The flange may have a mounting hole formed there through for mounting the base member to the drawer surround with a fastener. The first and second lower inner side walls and the lower center section may form a lower roller channel.

According to further embodiments, the drawer slide may further include an elongate support bar disposed in the lower roller channel and sized and configured to longitudinally slide relative to the lower roller support. The elongate support bar may have a top face and an opposing bottom face. The support bar may further have a first side face and an opposing second side face with the first and second side faces being respectively disposed between the top and bottom faces. The bottom face may be disposed in rolling contact with the first plurality of roll pins. The first side face may have a first lower inner race, and the second side face may have a second lower inner race. The first plurality of ball bearings may be respectively disposed between the first outer race and the first lower inner race, and between the second outer race and the second lower inner race. The first side face may have a first upper inner race, and the second side face may have a second upper inner race.

Further, the drawer slide may further include an upper roller support sized and configured to longitudinally slide relative to the support bar. The upper roller support may have first and second upper inner side walls and an upper center section disposed between the first and second upper inner side walls. The first upper inner side wall may be disposed adjacent the first side face. The second upper inner side wall may be disposed adjacent the second side face. The upper center section is disposed adjacent the top face. The first side face has a first upper inner race, the second side face has a second upper inner race, and the drawer slide further has a second plurality of ball bearings respectively disposed in the first and second upper inner races. The first and second upper inner side walls may respectively have upper bearing apertures formed there through, and the second plurality of ball bearings may be respectively disposed in the upper bearing apertures. The upper center section has upper roller openings formed there through. The drawer slide may further include a second plurality of roll pins respectively disposed in the lower roller openings in rolling contact with the top face.

Further, the drawer slide may further include an upper track member sized and configured to longitudinally slide relative to the upper roller support. The upper track member may have third and fourth outer walls and a track center section disposed between the third and fourth outer walls. The third and fourth outer walls and the track center section may define a second channel, and the upper roller support may be slidably disposed within the second channel. The first side face may have a first upper inner race, and the second side face may have a second upper inner race. The third outer wall may have a third outer race, and the fourth outer wall may have a fourth outer race. The drawer slide may further have a second plurality of ball bearings respectively disposed in the first and second upper inner races and the third and fourth outer races. The first and second upper inner side walls may respectively have upper bearing apertures formed there through, and the second plurality of ball bearings may be respectively disposed in the upper bearing apertures and the third and fourth outer races. The upper center section may have upper roller openings formed there through, and the drawer slide may further include a second plurality of roll pins respectively disposed in the lower roller openings in rolling contact with the top face and the track center section. The track portion may have a mounting hole formed there through for mounting the base member to the drawer surround with a fastener. The drawer slide may further include a drawer attachment member longitudinally attached to the upper track member. The drawer attachment member may have a mounting hole formed there through for mounting the drawer attachment member to the drawer with a fastener.

According to another embodiment of the invention, there is provided a drawer slide. The drawer slide includes a base member having a track portion with a track base and first and second outer walls extending from the track base. The first and second outer walls and the track base define a first channel along a longitudinal axis. The drawer slide further includes a lower roller support slidably disposed within the first channel along the longitudinal axis. The lower roller support having a first and second lower inner side walls and a lower center section disposed between the first and second lower inner side walls. The first and second lower inner side walls are respectively disposed adjacent the first and second outer walls of the track portion. The lower center section is disposed adjacent the track base. The first and second lower inner side walls and the lower center section form a lower roller channel. The lower center section has lower roller openings formed there through. The drawer slide further includes an elongate support bar disposed in the lower roller channel and sized and configured to longitudinally slide relative to the lower roller support. The elongate support bar has a top face and an opposing bottom face. The support bar further has a first side face and an opposing second side face with the first and second side faces being respectively disposed between the top and bottom faces. The drawer slide further includes an upper roller support sized and configured to longitudinally slide relative to the support bar. The upper roller support has first and second upper inner side walls and an upper center section disposed between the first and second upper inner side walls. The first upper inner side wall is disposed adjacent the first side face. The second upper inner side wall is disposed adjacent the second side face, the upper center section is disposed adjacent the top face. The drawer slide further includes an upper track member sized and configured to longitudinally slide relative to the upper roller support. The upper roller support has third and fourth outer walls and a track center section disposed between the third and fourth outer walls. The third and fourth outer walls and the track center section define a second channel. The upper roller support is slidably disposed within the second channel, the upper center section having upper roller openings formed there through. The drawer slide further includes a first plurality of roll pins respectively disposed orthogonal to the longitudinal axis in the lower roller openings in rolling contact with the track base and the bottom face. The drawer slide further includes a second plurality of roll pins respectively disposed orthogonal to the longitudinal axis in the upper roller openings in rolling contact with the top face and the track center section.

According to various embodiments, the first outer wall may have a first outer race, the second outer wall may have a second outer race, the third outer wall may have a third outer race, and the fourth outer wall may have a fourth outer race. The first side face may have a first lower inner race and a first upper race, and the second side face may have a second lower inner race and a second upper inner race. The drawer slide may further include a first plurality of ball bearings respectively disposed in the first and second lower inner side walls. The first plurality of ball bearings may be further respectively disposed between the first outer race and the first lower inner race and between the second outer race and the second lower inner race. The drawer slide may further include a second plurality of ball bearings respectively disposed in the first and second upper inner side walls. The second plurality of ball bearings may be further respectively disposed between the third outer race and the first upper inner race and between the fourth outer race and the second upper inner race.

According to another embodiment, there is provided a drawer slide. The drawer slide includes a first track portion having a first center section, a first upper wall extending from the first center section and a first lower wall extending from the first center section. The first upper wall, the first lower wall and the first center section define a first support bar channel. The first upper wall has a first upper race. The first lower wall has a first lower race. The drawer slide further includes a second track portion having a second center section, a second upper wall extending from the second center section and a second lower wall extending from the second center section. The second upper wall, the second lower wall and the second center section define a second support bar channel. The second upper wall has a second upper race. The second lower wall has a second lower race. The drawer slide further includes an elongate support bar having a top face and an opposing bottom face. The support bar further has a first side face and an opposing second side face with the first and second side faces being respectively disposed between the top and bottom faces. The top face, the first side face and the bottom face are disposed in the first support bar channel. The top face, the second side face and the bottom face are disposed in the second support bar channel. The elongate support bar is sized and configured to longitudinally slide relative to the first track portion. The top face has a first top race and a second top race. The bottom face has a first bottom race and a second bottom race. The drawer slider further includes a first plurality of ball bearings respectively disposed in the first upper race and the first top race. The drawer slider further includes a first plurality of spacers distributed among the first plurality of ball bearings and respectively disposed in the first upper race and the first top race. The drawer slider further includes a second plurality of ball bearings respectively disposed in the second upper race and the second top race. The drawer slider further includes a second plurality of spacers distributed among the second plurality of ball bearings and respectively disposed in the second upper race and the second top race. The drawer slider further includes a third plurality of ball bearings respectively disposed in the first lower race and the first bottom race. The drawer slider further includes a third plurality of spacers distributed among the third plurality of ball bearings and respectively disposed in the first lower race and the first bottom race. The drawer slider further includes a fourth plurality of ball bearings respectively disposed in the second lower race and the second bottom race. The drawer slider further includes a fourth plurality of spacers distributed among the fourth plurality of ball bearings and respectively disposed in the second lower race and the second bottom race.

The first and second track members may each formed from a singular piece of material. The first and second track members may each formed of a single piece of milled metal. The first, second, third and fourth ball bearings are respectively in rolling contact with the first upper race, the first top race, the second upper race, second top race, the first lower race, the first bottom race, the second lower race, and the second bottom race. The drawer slide is for use with a drawer and a drawer surround sized and configured to receive the drawer, and the first center section may have a mounting hole formed there through for mounting the first track member to the drawer surround with a fastener. The first track member may be connectable to the drawer surround, the second track member is connectable to the drawer. The second upper wall may have an upper surface disposed opposite the second upper race, the drawer is connectable at the upper surface.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a set of drawer slides of an embodiment of the present invention in an extended position as depicted with a drawer surround and a drawer (drawn in phantom lining);

FIG. 2 is a front view of the drawer slides, the drawer surround and the drawer of FIG. 1;

FIG. 3A is a perspective view showing a single drawer slide of a set of drawer slides of FIG. 1 in a retracted position;

FIG. 3B is a perspective view showing the single drawer slide of FIG. 3A in an extended position;

FIG. 4 is an exploded perspective view of the drawer slide of FIG. 3A;

FIG. 5 is an end cross-sectional view of the drawer slide of FIG. 4;

FIG. 6A is a perspective view of an upper roller support, a second plurality of ball bearings and a second plurality of roll pins of the drawer slide of FIG. 3A;

FIG. 6B is an exploded perspective of the upper roller support, the second plurality of ball bearings and the second plurality of roll pins of FIG. 6A;

FIG. 6C is a side view of the upper roller support, the second plurality of ball bearings and the second plurality of roll pins of FIG. 6A;

FIG. 7 is a front cross sectional view of a drawer slide with a portion of the drawer surround and drawer of FIGS. 1 and 2;

FIG. 8 is a side cross sectional view of the drawer slide with a portion of the drawer surround and the drawer of FIG. 1 as viewed along axis 8-8 of FIG. 7;

FIG. 8A is an enlarged side cross sectional view of a portion of the drawer slide of FIG. 8 with detail view of the trigger connection mechanism identified as 8A by the circle in FIG. 8;

FIG. 9 is a perspective view of a set of drawer slides of another embodiment of the present invention in a retracted position as depicted with a drawer surround and a drawer (drawn in phantom lining);

FIG. 10 is a perspective view of the drawer slides of FIG. 9 in an extended position as depicted with a drawer surround and a drawer (drawn in phantom lining);

FIG. 11 is a perspective view showing a single drawer slide of a set of drawer slides of FIG. 1 in a retracted position;

FIG. 12 is a perspective view showing the single drawer slide of FIG. 11 in an extended position;

FIG. 13 is an exploded perspective view of the drawer slide of FIG. 11;

FIG. 14 is a front cross sectional view of the drawer slide with a portion of the drawer surround and the drawer of FIG. 11 as viewed along axis 14-14;

FIG. 15 is a front cross sectional view of the drawer slide with a portion of the drawer surround and the drawer of FIG. 11 as viewed along axis 15-15.

### DETAILED DESCRIPTION

The detailed description set forth below in connection with the appended drawings is intended as a description of certain embodiments of an undermount drawer slide and related method of forming the same, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

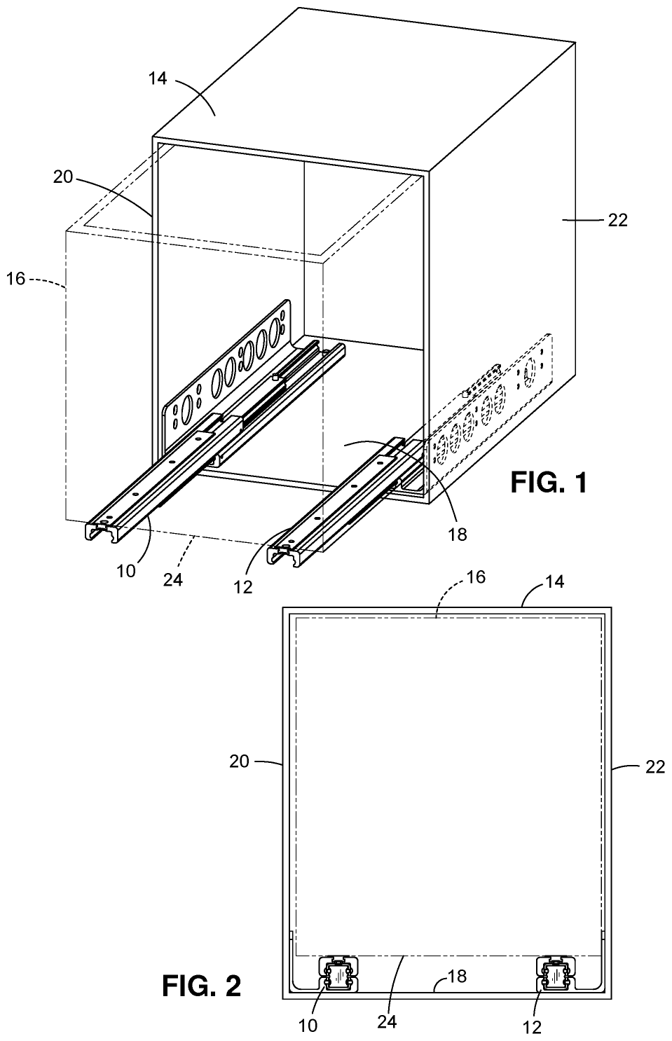

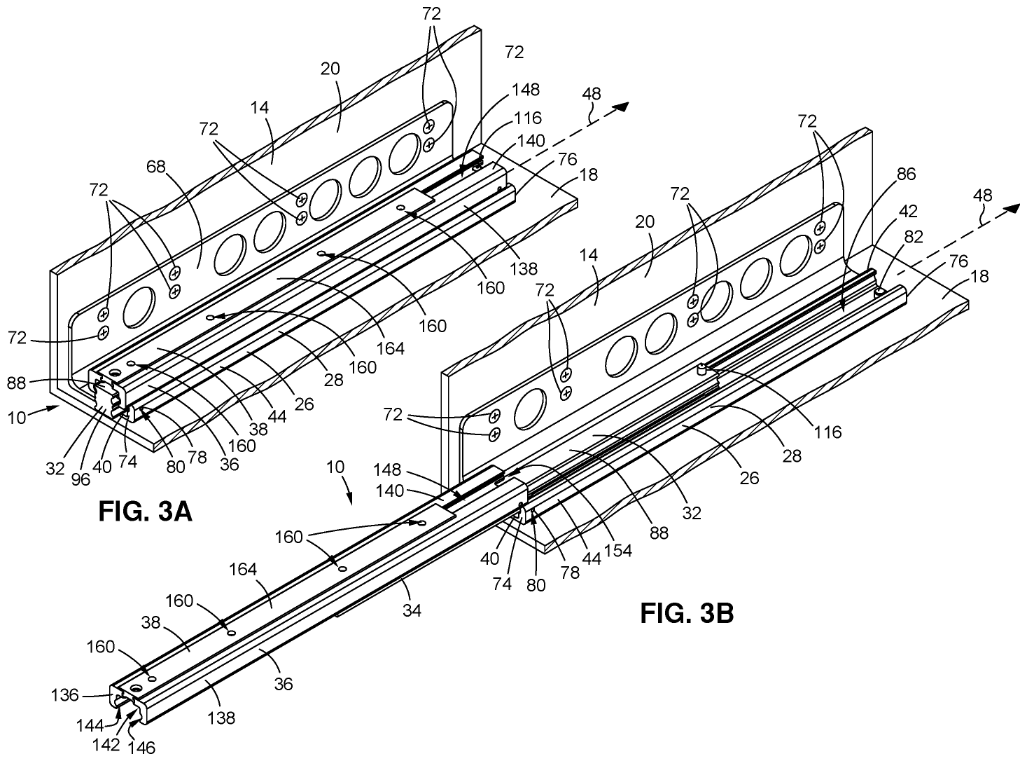

A drawer slide, which may be used in a system of two or more drawer slides, is described and shown in FIGS. 1-2, 3A-B, 4-5, 6A-C, 7-8, and 8A. Referring now to FIG. 1 there is depicted a perspective view of a set of drawer slides 10, 12 of an embodiment of the present invention in an extended position as depicted with a drawer surround 14 and a drawer 16 (drawn in phantom lining). FIG. 2 is a front view of the drawer slides 10, 12, the drawer surround 14 and the drawer 16 of FIG. 1. FIG. 3A is a perspective view showing the drawer slide 10 of FIG. 1 in a retracted position, and FIG. 3B is a perspective view showing the drawer slide 10 of FIG. 3A in an extended position.

The drawer slides 10, 12 with mirror image orientations of each other may be mounted on two opposing sides (left and right, for example) of the drawer surround 14 for supporting and providing the slide motion of the drawer 14 relative to the drawer surround 14. Each of the drawer slides 10, 12 include a plurality of sliding elements as is described in detail below. It will be appreciated that, the length and size of the slide members may be altered according to the dimension of the specific drawer to be supported, and the drawer slides attached to sidewalls and bottoms of the drawer surround or other specific requirements without departing from the scope of present invention.

The drawer slides 10, 12 may be grouped in a mirrored orientation. The drawer slides 12 may be attached to a bottom 18 of the drawer surround 14. Alternatively, or additionally, the drawer slides 10, 12 may be attached to sides 20, 22 of the drawer surround 14. The drawer slides 10, 12 are sized to take up the minimum height possible while still providing support for all the weight of the drawer 16 itself and the contents of the drawer combined. The drawer slides 10, 12 support the drawer 16 through an attachment to a drawer bottom 24 of the drawer 16. The drawer slides 10, 12 support the drawer 16 fully in both an extended position as shown in FIGS. 1 and 3B, and in a retracted position shown in FIG. 3B. Both the extended and retracted positions are discussed in greater detail below.

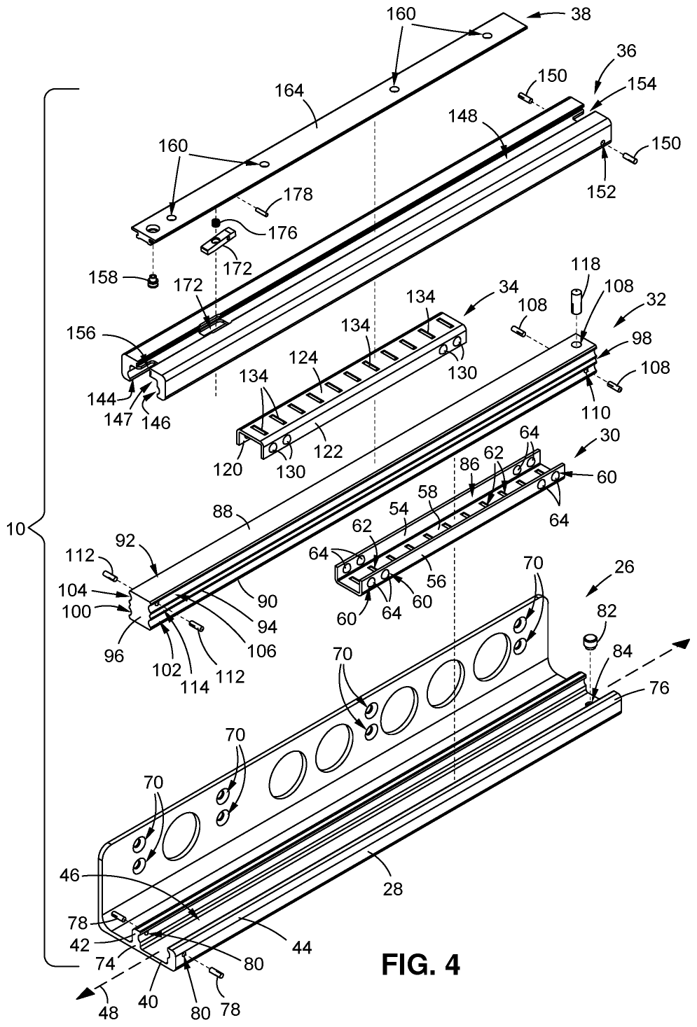

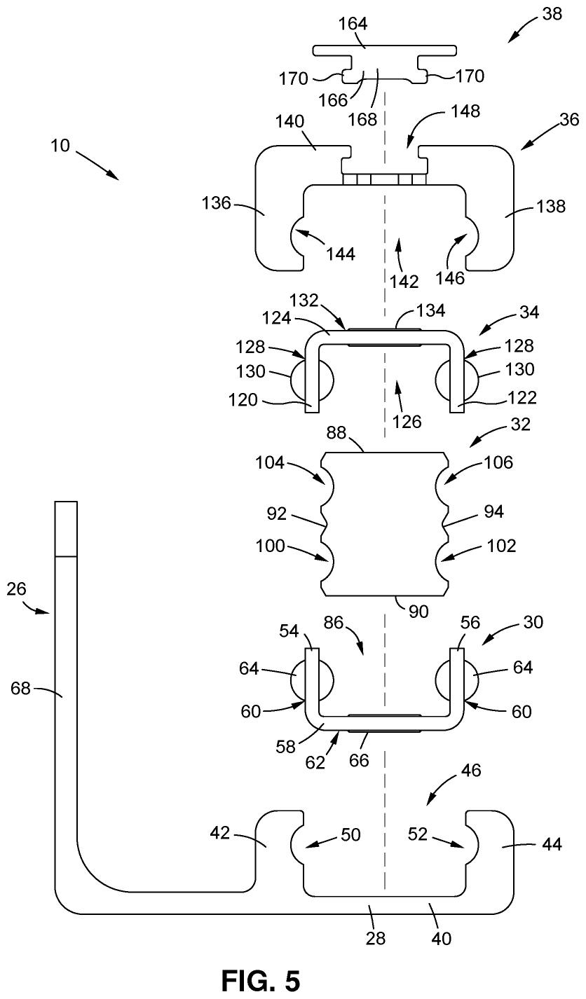

Referring additionally to FIG. 4 there is depicted an exploded perspective view of the drawer slide 10 of FIG. 3A. FIG. 5 depicts an end cross-sectional view of the drawer slide 10 of FIG. 4. The drawer slide may include a base member 26 with a track portion 28, a lower roller support 30, an elongate support bar 32, an upper roller support 34, an upper track member 36, and a drawer attachment member 38. Working in combination, the various components allow the drawer slide 10 to move from a retracted position shown in FIG. 3A in which the drawer slide (along with the drawer slide 12) may support the drawer 16 in an interior of the drawer surround 14, to an extended position shown in FIG. 3B in which at least a portion of the drawer 16 is moved outside of the drawer surround 14, allowing access to an interior of the drawer 16. In the retracted position, the elements are stacked one on top of the other. In the fully extended position, the components of the drawer slide 10 are cantilevered one over the other, with the base member remaining in place.

According to an aspect of the invention, there is provided a drawer slide, such as drawer slide 10. The drawer slide 10 includes the base member 26 having the track portion 28 with a track base 40 and first and second outer walls 42, 44 extending from the track base 40. The first and second outer walls 42, 44 and the track base 40 define a first channel 46 along a longitudinal axis 48. As best viewed in FIG. 5, the first outer wall 42 has a first outer race 50, and the second outer wall 44 has a second outer race 52. The drawer slide 10 further includes the lower roller support 30 slidably disposed within the first channel 46 along the longitudinal axis 48. The lower roller support 30 has first and second lower inner side walls 54, 56 and a lower center section 58 disposed between the first and second lower inner side walls 54, 56. The first and second lower inner side walls 54, 58 respectively are disposed adjacent the first and second outer walls 42, 44 of the track portion 28. The lower center section 58 is disposed adjacent the track base 40. The first and second lower inner side walls 54, 56 respectively have lower bearing apertures 60 formed there through. The lower center section 58 has lower roller openings 62 formed there through. The drawer slide 10 further includes a first plurality of ball bearings 64 respectively disposed in the lower bearing apertures 60 and the first and second outer races 50, 52. The drawer slide 10 further includes a first plurality of roll pins 66 respectively disposed orthogonal to the longitudinal axis 48 in the lower roller openings 62 in rolling contact with the track base 40.

It is contemplated that the first plurality of roll pins 66 is particularly suited to withstand the various compressive forces that would be imposed during operation of the drawer slide 10 to support and slide the drawer 16. Further, it is contemplated that the first plurality of ball bearings 64 are particularly suited to facilitate the relative sliding motion of the attached drawer 16 to the attached drawer surround 14. With this configuration, the drawer slide 10 may effectively mitigate racking of the attached drawer 16.

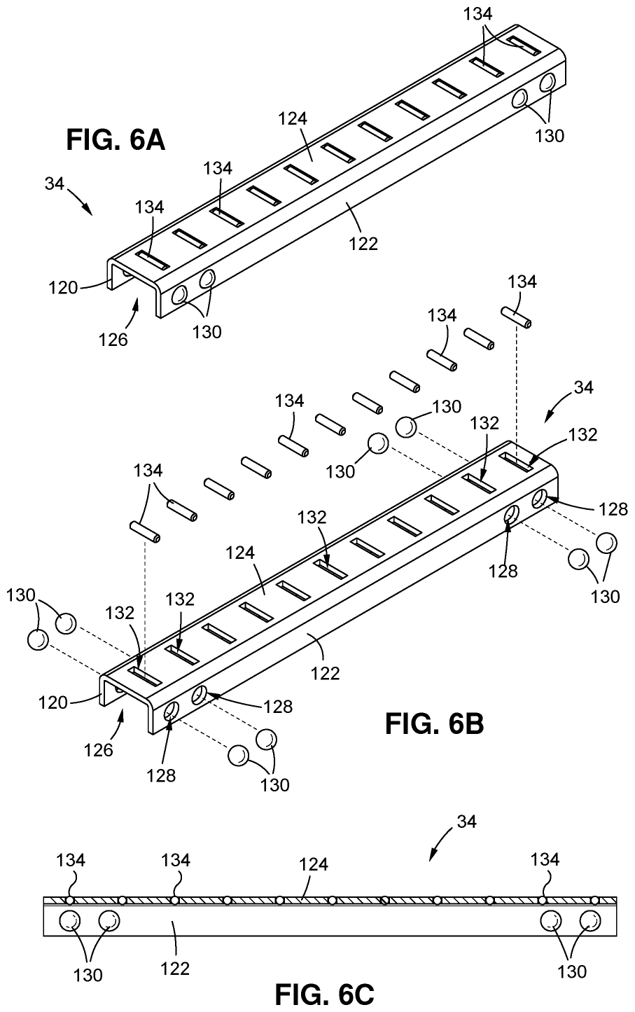

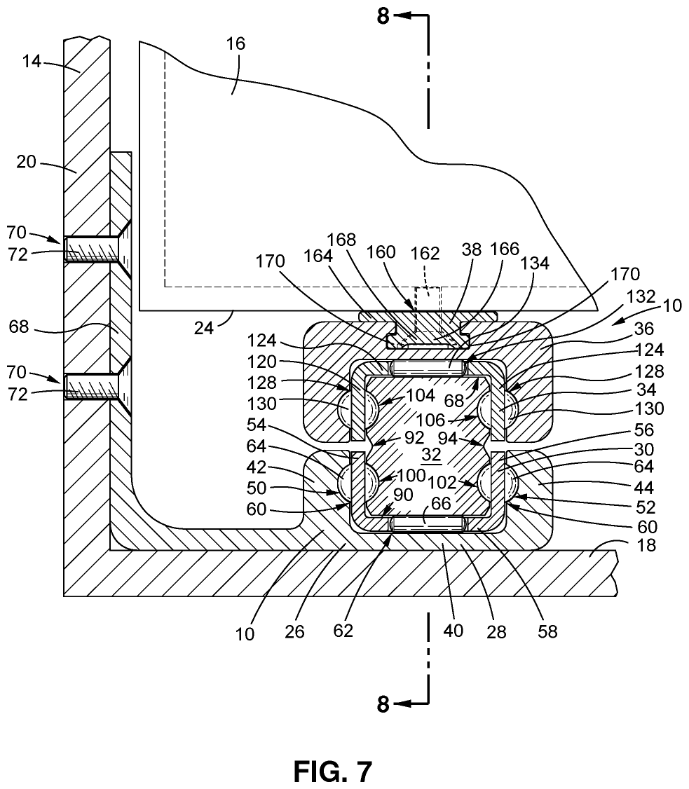

According to various embodiments, each of the first and second lower inner side walls 54, 56 has at least one of the lower bearing apertures 60 with a corresponding one of the first plurality of ball bearings 64. The lower bearing apertures 60 may be added in pairs and equally spaced along a length of the opposing first and second lower inner side walls 54, 56, or placed in any configuration which allows free movement of the various components of the drawer slide 10. The lower roller openings 62 may be distributed equally along a length of the lower roller support or placed in any configuration which allows free movement of the various components of the drawer slide 10.
the base member 26 may have an elongate flange 68 extending along the track portion 28. The flange 68 may be orthogonally disposed with regard to the track base 40. The track base may rest in a horizontal position and, though not required, flat against the bottom 18 of the drawer surround 14. The track base 40 may be attached directly to the bottom 18 of the drawer surround 14, such as via fasteners through the track base 40. As best seen in the cross sectional view of FIG. 7, the upwardly extending flange 68 may include mounting holes 70 formed there through for mounting the base member 26 to the drawer surround 14 with fasteners 72. In so doing, the drawer slide 10 may be attached to the side 20 of the drawer surround 14. As discussed above, the mounting holes 70 in which the fasteners 72 are placed may be countersunk so that heads of the fasteners 72 are flush with an interior surface of the flange 68. As shown in FIG. 6, the mounting holes 70 and the corresponding fasteners 72 may be in a plurality of locations about the flange 68, and may be grouped in pairs. Alternatively, the fasteners 72 may be located and grouped in any way that would allow the base member 26 to be attached securely to the drawer surround 14.

The base member 26 may be skeletonized. That is, portions of the base member 26, particularly the flange 68 may have material cut away or relieved to reduce weight without negatively impacting the strength of the base member 26 in operation. As shown in the figures, the material may be cut away in the shape of various circles. Alternatively, the material may also be cut away in the shape of the square, rectangle, oval, trapezoidal, or any other shape which removes the desired amount of material in the desired location.

The track portion 28 includes a front end 74 and a rear end 76. As mentioned above, the lower roller support 30 is slidably disposed within the first channel 46 along the longitudinal axis 48. In operation, the lower roller support 30 may longitudinally move along the first channel 46 from adjacent the front and rear ends 74, 76. As best seen in the exploded perspective view of FIG. 4, the track portion 28 may include blocking pins 78 and blocking pin cavities 80 adjacent the front end 74 of the track portion 28. The blocking pin cavities 80 may be respectively formed in the first and second outer walls 44, 46 adjacent the front end 74. A portion of each of the blocking pins 78 is respectively recessed in the blocking pin cavities 80 with a remainder of each extending laterally inward into the first channel 46. The track portion 28 further may include a slide block 82 and a slide block receiving cavity 84 formed in the track base 40 adjacent the rear end 76 of the track portion 28. A portion of the slide block 82 is recessed in the slide block receiving cavity 84 with a remainder extending upward into the first channel 46. With the lower roller support 30 disposed in the first channel 46, it is contemplated that the blocking pins 78 and the slide block 82 may be effectively used to maintain the lower roller support 30 within the first channel 46 and prevent the lower roller support 30 from moving past either of the front or rear ends 74, 76.

The first and second lower inner side walls 54, 56 and the lower center section 58 of the lower roller support 30 may form a lower roller channel 86 (as best seen in the cross sectional end view of FIG. 5). As mentioned above, the drawer slide 10 may further include the elongate support bar 32. The support bar 32 is cooperatively sized and configured with the lower roller support 30 such that the support bar 32 is disposed in and received by the lower roller channel 86. Further, the support bar 32 is sized and configured to longitudinally slide relative to the lower roller support 30.

The support bar 32 has a top face 88 and an opposing bottom face 90. The support bar 32 may further have a first side face 92 and an opposing second side face 94 with the first and second side faces 92, 94 being respectively disposed between the top and bottom faces 88, 90. The bottom face 90 is disposed in rolling contact with the first plurality of roll pins 66. In this regard, the combination of the bottom face 90 of the support bar 32, the lower roller openings 62 of the lower roller support 30, and the track base 40 of the track portion 28 substantially surround the first plurality of roll pins 66. Moreover, each of the support bar 32, the lower roller support 30, and the track portion 28 all contact the first plurality of roll pins 66 but not each other in order to reduce friction while facilitating sliding relative movement of the support bar 32, the lower roller support 30, and the track portion 28.

The first side face 92 has a first lower inner race 100, and the second side face 94 has a second lower inner race 102. The first plurality of ball bearings 64 are respectively disposed between the first outer race 50 of the track portion 28 and the first lower inner race 100 of the support bar 32, and between the second outer race 20 of the track portion 28 and the second lower inner race 102 of the support bar 32.

The first side face 92 further has a first upper inner race 104, and the second side face 94 may have a second upper inner race 106. In this regard, the first upper inner race 104 is positioned above and parallel to the first lower inner race 100. Similarly, the second upper inner race 106 is positioned above and parallel to the second lower inner race 102.

The first and second lower inner races 100, 102 of the support bar 32 may respectively include blocking pins 108 and blocking pin cavities 110 adjacent the support bar rear end 98. The blocking pins 108 partially laterally extend into the first and second lower inner races 100, 102. The blocking pins 108 prevent the lower roller support 30 from sliding off the support bar rear end 98.

The first and second upper inner races 104, 106 of the support bar 32 may respectively include blocking pins 112 and blocking pin cavities 114 adjacent the support bar front end 96. The blocking pins 112 partially laterally extend into the first and second upper inner races 104, 106. The blocking pins 112 prevent the upper roller support 34 from sliding off the support bar front end 96.

The support bar 32 may further include a blocking stud 116 placed in a blocking stud cavity 118 in the top face 88 adjacent the support bar rear end 98. The blocking stud 116 extends partially upward from the top face 88 and is used to interfere with rearward movement of the upper track member 36 past the support bar rear end 98.

Further, the drawer slide further includes the upper roller support 34. The upper roller support 34 is sized and configured to longitudinally slide relative to the support bar 32. The upper roller support 34 has first and second upper inner side walls 120, 122 and an upper center section 124 disposed between the first and second upper inner side walls 120, 122. The upper roller support 34 has an orientation which mirrors that of the lower roller support 30. The first and second upper inner side walls 120, 122 and the upper center section 124 form an upper roller channel 126. The upper roller channel 126 is sized and configured to receive the support bar 32 therein. The first upper inner side wall 120 may be disposed adjacent the first side face 92 of the support bar 32. The second upper inner side wall 122 may be disposed adjacent the second side face 94 of the support bar 32. The upper center section 124 is disposed adjacent the top face 88 of the support bar 32.

The first and second upper inner side walls 120, 122 respectively have upper bearing apertures 128 formed there through. The drawer slide 10 further includes a second plurality of ball bearings 130. Each of the second plurality of ball bearings 130 is respectively disposed in the upper bearing apertures 128. Each of the second plurality of ball bearings 130 is respectively disposed in the first and second upper inner races 104, 106 of the support bar 30. Each of the first and second upper side walls 120, 122 has at least one of the upper bearing apertures 128 with a corresponding one of the second plurality of ball bearings 130. The upper bearing apertures 128 may be added in pairs and equally spaced along a length of the opposing first and second upper inner side walls 120,122 or placed in any configuration which allows free movement of the various components of the drawer slide 10.

The upper center section 124 has upper roller openings 132 formed there through. The drawer slide 10 further includes a second plurality of roll pins 134 respectively disposed in the lower roller openings 132 in rolling contact with the top face 88 of the support bar 30. The upper roller openings 132 may be distributed equally along a length of the upper roller support 34 or placed in any configuration which allows free movement of the various components of the drawer slide 10.

Further, the drawer slide 10 further includes the upper track member 36. The upper track member 36 is sized and configured to longitudinally slide relative to the upper roller support 34. The upper track member 36 support has third and fourth outer walls 136, 138 and a track center section 140 disposed between the third and fourth outer walls 136, 138. The third and fourth outer walls 136, 138 extend downwardly towards the upper roller support 30. The third and fourth outer walls 136, 138 and the track center section 140 define a second channel 142. The upper track member 36 is sized and configured to receive the upper roller support 34 in the second channel 142. The upper roller support 34 may be slidably disposed within the second channel 142.

The third outer wall 136 may have a third outer race 136, and the fourth outer wall 136 may have a fourth outer race 138. Each of the second plurality of ball bearings 130 is respectively disposed in and between the first inner upper race 104 of the support bar 30 and the third upper outer race 136 of the upper track member 36, and between second upper inner race 106 of the support bar 30 and the fourth outer race 138 of the upper track member 136.

As mentioned above, the upper center section 124 has the second plurality of roll pins 134 disposed in the upper roller openings 132. Each of the second plurality of roll pins 134 are respectively disposed in rolling contact with the track center section 140 of the upper track member 36 in addition to the top face 88 of the support bar 32.

The upper track member 36 further includes a rail capture channel 148. The rail capture channel 148 is disposed opposite that of the second channel 142. The upper track member 14 may further include two blocking pins 150 located in blocking pin bores 152 extending through the third and fourth side walls 144, 146 into the second channel 142. The blocking pins 150 prevent the upper roller support 16 from moving rearward beyond the second channel 142. The rail capture channel 148 may include a rear end slot 154. The rear end slot 154 may be configured to receive the blocking stud 116 to prevent rearward movement of the upper track member 14 beyond the support bar 36. The rail capture channel 148 may include a front end slot 156 at an opposite end of the upper track member 36 from the rear end slot 154. The front end slot 156 may be configured to receive a set screw 158 which may be used to position the drawer attachment member 38 on the upper track member 36.

The drawer attachment member 38 is longitudinally attached to the upper track member 36. The drawer attachment member 38 may have mounting holes 160 formed there through for mounting the drawer attachment member 38 to the drawer 16 with fasteners 162. The drawer attachment member 38 may include an attachment plate 164 and a rail 166. The mounting holes 160 may include a portion which is countersunk, allowing the fasteners 162 used to attach the attachment plate 164 to the drawer 16 to be countersunk and rest flush with a surface of the drawer attachment member 38.

The drawer attachment member 12 may be connected to an upper track member 14. The rail capture channel 148 may securely hold the rail 15 of the drawer attachment member 12. In this regard, the rail 166 may be formed with a transverse cross section in an inverted “T” configuration. In other words, the transverse cross section may have a central rib 168 which extends away from the attachment plate 164. An outermost portion of the central rib 168 may have two arms 170 extending perpendicularly from the central rib 168. The two arms 170 extend substantially 180 degrees from one another, thus completing the “T” shape.

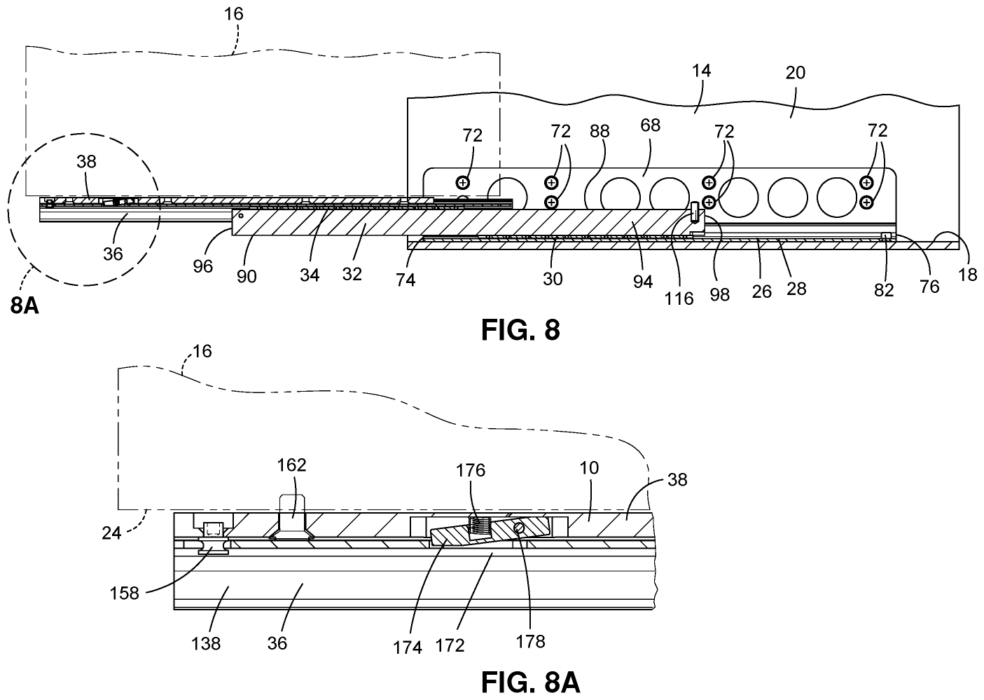

As best seen in FIGS. 4 and 8A, the rail capture channel 148 may further include a trigger capture cavity 172 which allows a user to reach through to manipulate a trigger lock mechanism. The trigger lock mechanism may include a locking arm 172, a biasing element 176, and a pivot pin 178. The biasing element 176 may be, for example, a spring or a piece of resilient material which bias one end of the locking arm 172 away from the drawer attachment member 38 and a second, opposite, end of the locking arm 172 toward the drawer attachment member 38. The pivot pin 178 may be inserted through a bore in the rail 166 with a cross bore of the pivot pin 178 to form a common bore. The pivot pin 178 attaches the locking arm 172 to the rail 166 by resting in the common bore. The biasing element 176 biases the locking arm 174 so that the locking arm 174 rotates around the pivot pin 178 until a rear portion of the locking arm 174 contacts the rail 166. When a user reaches through in the trigger capture cavity 172, the user may exert a force on the locking arm 172 which counteracts the biasing of the biasing element 176. By doing this, the locking arm 174 may be moved free of the trigger capture cavity 172, and the drawer attachment member 38 is removed from the drawer slide 10 by sliding the drawer attachment member 38 out of the rail capture channel 148 when the drawer slide 10 is in the extended position shown in FIGS. 1, 3B, and 8.

The components, specifically, the base member 26, the lower roller support 30, the support bar 32, the upper roller support 34, the upper track member 36, and the drawer attachment member 38, may be formed from a single piece of material, for example, a lightweight metal such as aluminum or titanium. The components may be formed by machining, such as milling, from a single piece of material. Alternatively, the components may be formed by forging them from a single piece of material. Or, the components may be cast, or formed by any other method which allows the components to be formed from a single piece of material with sufficient strength for operation. Because the components may be, for example, milled or forged from a single piece of material, they may include fewer weak points created by the connection of various moving and non-moving parts. Thus, when the components are milled from a single piece of material, the base member 26, for example, is less subject to being deformed by twisting or bending due to the additional rigidity provided by the milling of the components.

As can best be seen in FIGS. 1, 3A and 3B, and as discussed above, in operation, the drawer slide 10 may be moved from a first position in which the drawer 16 is contained within the drawer surround 14, and the components are substantially stacked one upon another, to a second position, in which the drawer slide 10 is extended outward, with several of the components cantilevered out over the others, and the drawer 16 made accessible. Because the drawer attachment member 38 is attached to the drawer by the fasteners 162, a user may pull on the drawer 16 to operate the drawer slide 10, or system of drawer slides 10, 12.

When a user pulls on the drawer 16, first, the combined drawer attachment member 38 and upper track member 36 sub-assembly translate toward the user as the components roll over the upper roller support 14 as the second plurality of roll pins 134 and the second plurality of ball bearings 130 turn. As the upper track member 36 moves toward the user, at some point the blocking pins 150 on the upper track member 36 come in to contact the upper roller support 34. Once contact between the upper roller support 34 and the blocking pins 150 is made, the upper track member 36 pulls the upper roller support 34 along, and the second plurality of roll pins 134 roll along the top face 88 of the support bar 32 and the second plurality of ball bearings 130 respectively roll along the first and second upper inner races 104, 106 of the support bar 32. The upper roller support 34 continues to roll along the support bar 32 until the upper roller support 34 contacts the blocking pins 112 adjacent the support bar front end 96. When contact is made, the drawer attachment member 38, the upper track member 36, and the upper roller support 34 stop moving relative to the support bar 32. A length of the upper roller support 34 determines the amount of cantilever of the upper track member 36 past the support bar front end 96.

As the user continues to move the drawer slide 10, the support bar 32 begins to move. The first plurality of roll pins 66 and the first plurality of ball bearings 64 of the lower roller support 30 roll as the support bar 32 moves over and along them until the blocking pins 108 contact the lower roller support 30. Once the lower roller support 30 contacts the blocking pins 108, the support bar 32 pulls the lower roller support 30 along with it. The first plurality of roll pins 66 and the first plurality of ball bearings 64 of the lower roller support 30 then roll along the track portion 28 of the base member 26 until the lower roller support 30 contacts the blocking pins 78 of the track portion 28. A length of the lower roller support 28 controls the amount that the support bar 32 cantilevers over the base member 26. This is the fully extended or second position.

As can be seen in FIGS. 8 and 8A, in the second position, a user may remove the drawer 26 when the drawer slide 10 is in the second position. To remove the drawer 16 from the drawer slide 10, the user reaches under in the upper track member 36 and finds the trigger capture cavity 172. The user reaches in the trigger capture cavity 172 and exerts an upward force on the locking arm 172 which counteracts the biasing of the biasing element 176. By doing this, the locking arm 172 may be moved free of the trigger capture cavity 172, and the drawer attachment member 38 may be removed from the drawer slide 10 by sliding the drawer 16 off. The drawer attachment member 38 stays attached to the drawer 16 when the drawer 16 is removed from the drawer slide 10. To reattach the drawer 16, the user slides the rail 166 in through an exposed end of the rail capture channel 148 and along the rail capture channel 148 until the biased locking arm 172 clicks in to place.

To return the drawer slide 10 to the first position, the user exerts a rearward force on the drawer 16. The drawer slide 10 then collapses in substantially the same order of components in which the drawer slide 10 was extended. Specifically, the drawer attachment member 38 and the upper track member 36 will begin to move, rolling over and alongside the upper roller support 34. Eventually the rear end slot 154 makes contact with the blocking stud 116. Once contact is made, the drawer attachment member 38, the upper track member 36 and the support bar 32 will move in unison, rolling over the lower roller support 30 until the support bar 32 makes contact with the slide block 82. Once contact between the support bar 32 and the slide block 82 is made, the drawer slide 10 is returned to the second position. It will be noted that, in the second position, each of the first ends of the various components, that is, the upper track member 36, the support bar 32, and the track portion 28, all substantially align.

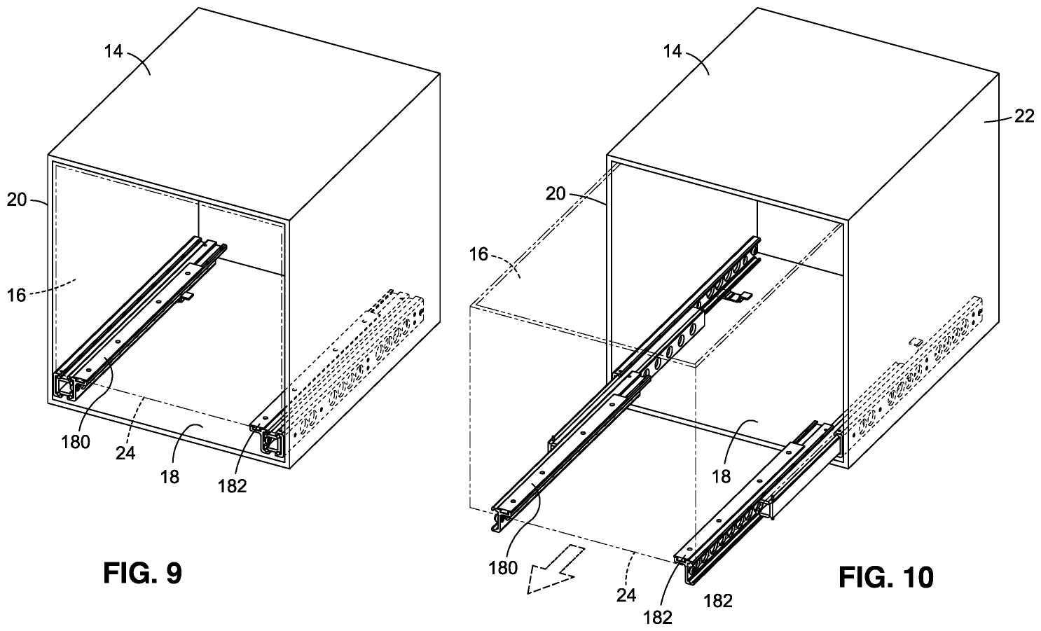

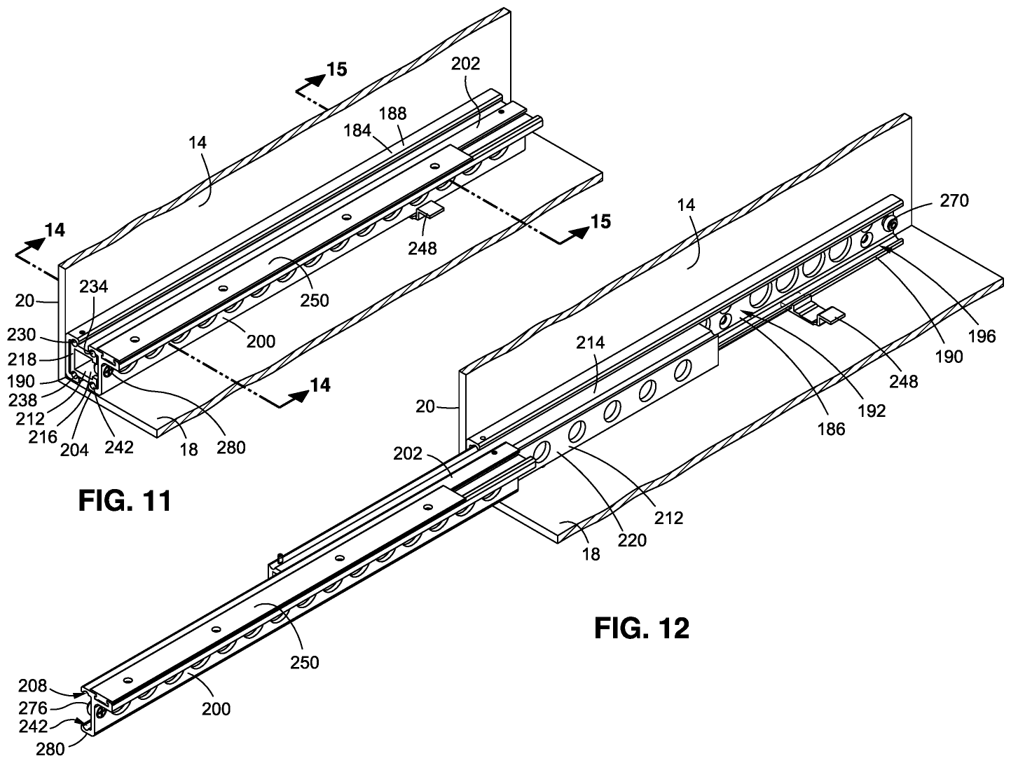

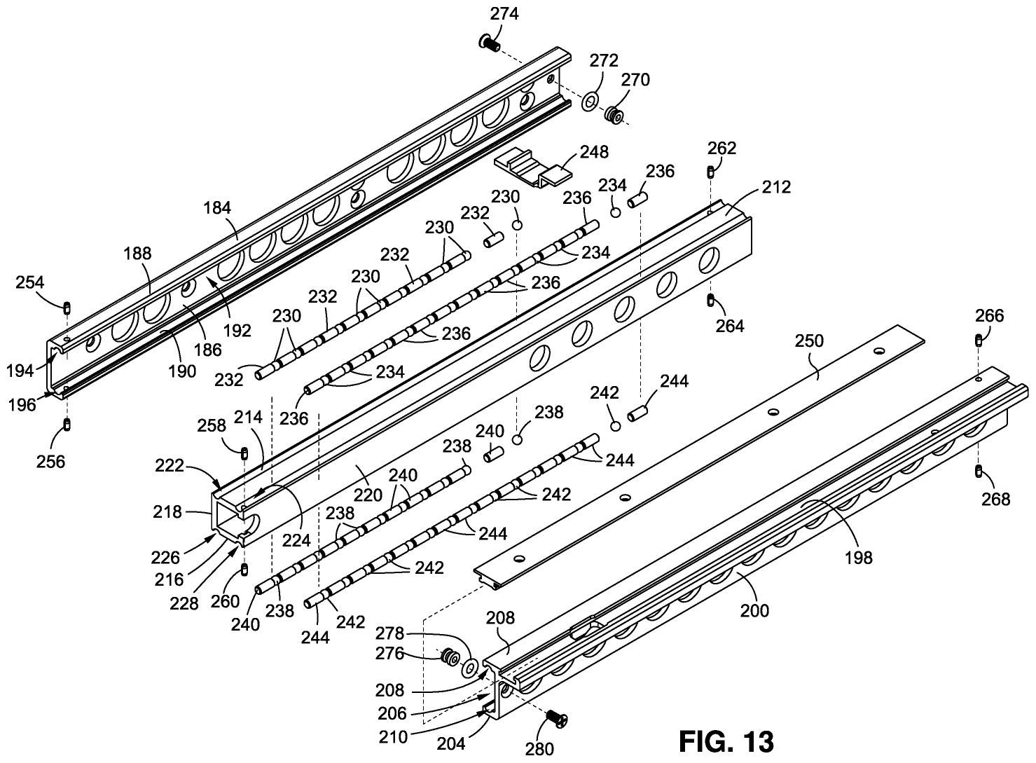

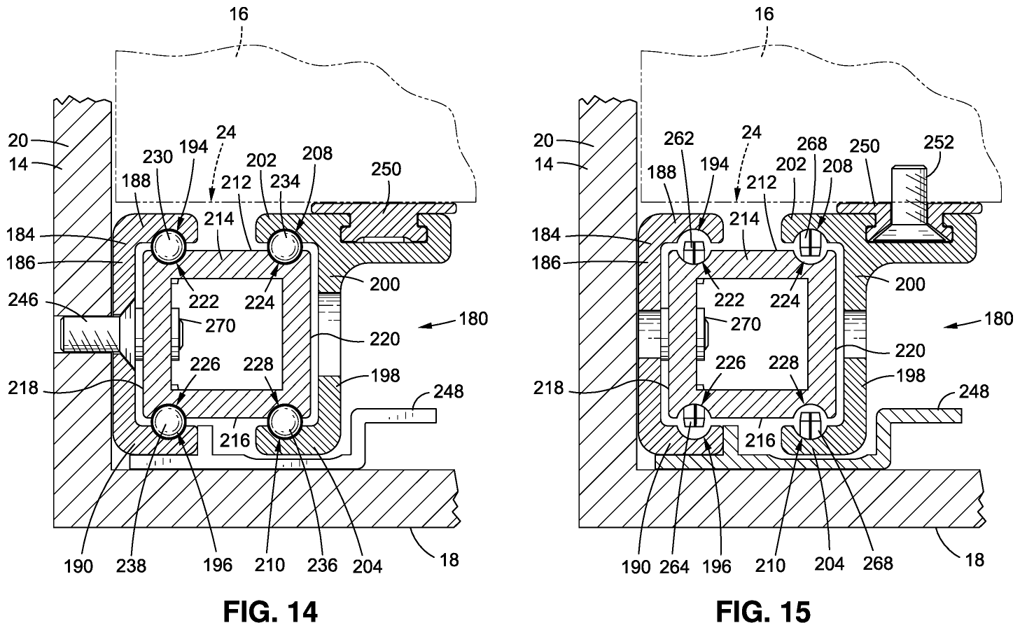

Referring now to FIG. 9 there is a perspective view of a set of drawer slides 180, 182 of another embodiment of the present invention in a retracted position as depicted with the drawer surround 14 and the drawer 16 (drawn in phantom lining) FIG. 10 is a perspective view of the drawer slides of FIG. 9 in an extended position as depicted with a drawer surround and a drawer (drawn in phantom lining). FIG. 11 is a perspective view showing the drawer slide 180 in a retracted position. FIG. 12 is a perspective view showing of the drawer slide 180 in an extended position. FIG. 13 is an exploded perspective view of the drawer slide 180. FIG. 14 is a front cross sectional view of the drawer slide 180 with a portion of the drawer surround 14 and the drawer 16 as viewed along axis 14-14. FIG. 15 is a front cross sectional view of the drawer slide 180 with a portion of the drawer surround 14 and the drawer 16 of FIG. 11 as viewed along axis 15-15.

According to another embodiment, there is provided the drawer slide 180. The drawer slide 180 includes a first track portion 184 having a first center section 186, a first upper wall 188 extending from the first center section 186 and a first lower wall 190 extending from the first center section 186. The first upper wall 188, the first lower wall 190 and the first center section 186 define a first support bar channel 192. The first upper wall 188 has a first upper race 194. The first lower wall 190 has a first lower race 196. The drawer slide 180 further includes a second track portion 198 having a second center section 200, a second upper wall 202 extending from the second center section 200 and a second lower wall 204 extending from the second center section 200. The second upper wall 202, the second lower wall 204 and the second center section 200 define a second support bar channel 206. The second upper wall 202 has a second upper race 208. The second lower wall 204 has a second lower race 210.

The drawer slide 180 further includes an elongate support bar 212 having a top face 214 and an opposing bottom face 216. The support bar 212 further has a first side face 218 and an opposing second side face 220 with the first and second side faces 218, 220 being respectively disposed between the top and bottom faces 214, 216. The top face 214, the first side face 218 and the bottom face 216 are disposed in the first support bar channel 192. The top face 214, the second side face 220 and the bottom face 216 are disposed in the second support bar channel 206. The elongate support bar 212 is sized and configured to longitudinally slide relative to the first track portion 184. The top face 214 has a first top race 222 and a second top race 224. The bottom face 216 has a first bottom race 226 and a second bottom race 228.

The drawer slide 180 further includes a first plurality of ball bearings 230 respectively disposed in the first upper race 194 and the first top race 222. The drawer slide 180 further includes a first plurality of spacers 232 distributed among the first plurality of ball bearings 230 and respectively disposed in the first upper race 194 and the first top race 222. The drawer slide 180 further includes a second plurality of ball bearings 234 respectively disposed in the second upper race 208 and the second top race 224. The drawer slide 180 further includes a second plurality of spacers 236 distributed among the second plurality of ball bearings 234 and respectively disposed in the second upper race 208 and the second top race 224. The drawer slide 180 further includes a third plurality of ball bearings 238 respectively disposed in the first lower race 196 and the first bottom race 226. The drawer slide 180 further includes a third plurality of spacers 240 distributed among the third plurality of ball bearings 238 and respectively disposed in the first lower race 196 and the first bottom race 226. The drawer slide 180 further includes a fourth plurality of ball bearings 242 respectively disposed in the second lower race 210 and the second bottom race 228. The drawer slide 180 further includes a fourth plurality of spacers 244 distributed among the fourth plurality of ball bearings 242 and respectively disposed in the second lower race 210 and the second bottom race 228.

It is contemplated that the spacers 232, 236, 240, 244 distribute the vertical loading upon the ball bearings 230, 234, 238, 242 and the first track portion 184, the second track portion 198, and the support bar 212 across the longitudinal distance of the first track portion 184, the second track portion 198, and the support bar 212. Such distribution tends to mitigate against undue loading an any particular longitudinal location and mitigates undue flexure or deflection of the first track portion 184, the second track portion 198, and the support bar 212.

The drawer slide 180 may be mounted to the drawer surround 14. In this regard a fastener 246 may be provided to attached the first track portion 184 to the drawer surround 14 via attachment of the first center section 186. With the first track portion 184 attached to the drawer surround 14, the support bar 212 and the second track portion 198 are configured to translate relative to the first track portion 184.

A base support 248 may be provided. The base support 248 may be attached to the first lower wall 190 and is configured to extend in a direction away from the first censer section 186 under the second lower wall 204 of the second traction portion 198. The base support 248 may be attached to the first lower wall 190 by press fit attached, glued, interlocked or any other well known techniques. The base support 248 may rest upon drawer surround bottom 18 and provide support for the overall drawer slide 180. The base support 248 also has the effect of vertically spacing the drawer slide 180 from the drawer surround bottom 18 so as to allow the second track portion 198 to freely slide without dragging on the drawer surround bottom 18. Additionally, the base support 248 may extend beyond the second traction portion 198 and may be used to interact and index the relative position of the first track portion 184.

A drawer attachment member 250 may be attached to the second track portion 198 adjacent the second upper wall 202. The in embodiment depicted the drawer attachment member 250 is attached to second upper wall 202 by an interlocking tongue and groove arrangement. A fastener 252 may be used to attach the drawer 16 at the drawer bottom 24 to the drawer attachment member 250. This attaches the drawer 16 to the second track portion 198. Movement of the drawer 16 results in movement of the attached second track portion 198.

The drawer slide 180 may be provided with stoppers 254, 256, 258, 260, 262, 264, 266, 268. The stopper 254 may be attached to the first upper wall 188 in the first upper race 194 at an end of the first track portion 184. The stopper 256 may be attached to the first lower wall 190 in the first lower race 196 at an end of the first track portion 184. The stopper 258 may be attached to the top face 214 in the second top race 224 at an end of the support bar 212. The stopper 260 may be attached to the bottom face 216 in the second bottom race 228 at an end of the support bar 212. The stopper 262 may be attached to the top face 214 in the first top race 222 at an opposite end of the support bar 212 from the stopper 258. The stopper 264 may be attached to the bottom face 216 in the first bottom race 226 at an opposite end of the support bar 212 from the stopper 260. The stopper 266 may be attached to the second upper wall 202 in the second upper race 208 at an end of the second track portion 198. The stopper 268 may be attached to the second lower wall 204 in the second lower race 210 at an end of the second track portion 198. The stoppers 254, 256, 258, 260, 262, 264, 266, 268 may be attached may being press fit into place.

The stoppers 254, 262 are contemplated to be positioned to bound the first plurality of ball bearings 230 and the first plurality of spacers 232 within the first upper race 194 and the first top race 222. The stoppers 258, 266 are contemplated to be positioned to bound the second plurality of ball bearings 234 and the second plurality of spacers 236 within the second upper race 208 and the second top race 224. The stoppers 256, 264 are contemplated to be positioned to bound the third plurality of ball bearings 238 and the third plurality of spacers 240 within the first lower race 196 and the first bottom race 226. The stoppers 260, 268 are contemplated to be positioned to bound the fourth plurality of ball bearings 242 and the fourth plurality of spacers 244 within the second lower race 210 and the second bottom race 210.

It is contemplated that the sizing and number of the ball bearings 230, 238 and the number of lengths of the spacers 232, 240 will define the extent by which the support bar 212 may longitudinally move away or extend from the parallel first traction portion 184. This is because the stoppers 254, 256, 262, 264 will eventually engage the rows of the ball bearings 230, 238 and the spacers 232, 240. Likewise, it is contemplated that the sizing and number of the ball bearings 234, 242 and the number of lengths of the spacers 236, 244 will define the extent by which the second track portion 198 may longitudinally move away or extend from the parallel support bar 214. This is because the stoppers 258, 260, 266, 268 will eventually engage the rows of the ball bearings 234, 242 and the spacers 236, 244.

An end stop 270 may be provided that is attached to the first track portion 184 in the first support bar channel 192. The end stop 270 may be attached using a washer 272 and a fastener 274. The end stop 270 is used to prevent the support bar 212 from moving beyond the first track portion 184 in a direction into the drawer surround 14. An end stop 276 may be provided that is attached to the second track portion 198 in the second support bar channel 206. The end stop 276 may be attached using a washer 278 and a fastener 280. The end stop 276 is used to prevent the support bar 212 from moving beyond the second track portion 198 in a direction out of the drawer surround 14.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1-30. (canceled)

31. A drawer slide comprising:
a first track portion having a first center section, a first upper wall extending from the first center section and a first lower wall extending from the first center section, the first upper wall, the first lower wall and the first center section defining a first support bar channel, the first upper wall having a first upper race, the first lower wall having a first lower race;
a second track portion having a second center section, a second upper wall extending from the second center section and a second lower wall extending from the second center section, the second upper wall, the second lower wall and the second center section defining a second support bar channel, the second upper wall having a second upper race, the second lower wall having a second lower race;
a hollow, elongate support bar having a top face and an opposing bottom face, the support bar further has a first side face and an opposing second side face with the first and second side faces being respectively disposed between the top and bottom faces, the top face, the first side face and the bottom face being disposed in the first support bar channel, the top face, the second side face and the bottom face being disposed in the second support bar channel, the elongate support bar being sized and configured to longitudinally slide relative to the first track portion, the top face having a first top race and a second top race, the bottom face having a first bottom race and a second bottom race;
a first plurality of ball bearings respectively disposed in the first upper race and the first top race;
a second plurality of ball bearings respectively disposed in the second upper race and the second top race;
a third plurality of ball bearings respectively disposed in the first lower race and the first bottom race; and
a fourth plurality of ball bearings respectively disposed in the second lower race and the second bottom race.

32. The drawer slide of claim 31, further comprising:
a first plurality of spacers distributed among the first plurality of ball bearings and respectively disposed in the first upper race and the first top race;
a second plurality of spacers distributed among the second plurality of ball bearings and respectively disposed in the second upper race and the second top race;
a third plurality of spacers distributed among the third plurality of ball bearings and respectively disposed in the first lower race and the first bottom race; and
a fourth plurality of spacers distributed among the fourth plurality of ball bearings and respectively disposed in the second lower race and the second bottom race.

33. The drawer slide of claim 31, wherein the first and second track members are each formed from a singular piece of material.

34. The drawer slide of claim 31, wherein the first and second track members are each formed of a single piece of milled metal.

35. The drawer slider of claim 31, wherein the first, second, third and fourth ball bearings are respectively in rolling contact with the first upper race, the first top race, the second upper race, second top race, the first lower race, the first bottom race, the second lower race, and the second bottom race.

36. The drawer slide of claim 31, wherein the drawer slide is for use with a drawer and a drawer surround sized and configured to receive the drawer, the first center section has a mounting hole formed there through for mounting the first track member to the drawer surround with a fastener.

37. The drawer slide of claim 31, wherein the drawer slide is for use with a drawer and a drawer surround sized and configured to receive the drawer, the first track member is connectable to the drawer surround, the second track member is connectable to the drawer.

38. The drawer slide of claim 37, wherein the second upper wall has an upper surface disposed opposite the second upper race, the drawer is connectable at the upper surface.

39. The drawer slide of claim 38, further comprising a drawer attachment member attachable to the second track portion adjacent the second upper wall.

40. The drawer slide of claim 39, wherein the drawer attachment member is attachable to the second upper wall by an interlocking tongue and groove arrangement.

41. The drawer slide of claim 31, wherein the drawer slide is for use with a drawer and a drawer surround sized and configured to receive the drawer, the drawer slide further comprising a base support attachable to the first lower wall, the base support being configured to space the first lower wall from the drawer surround.

42. The drawer slide of claim 31, further comprising a stopper attached to the first upper wall in the first upper race at an end of the first track portion.

43. The drawer slide of claim 31, further comprising a stopper attached to the first lower wall in the first lower race at an end of the first track portion.

44. The drawer slide of claim 31, further comprising a first stopper attached to the top face in the second top race at an end of the support bar.

45. The drawer slide of claim 44, further comprising a second stopper attached to the top face in the first top race at an opposite end of the support bar from the first stopper.

46. The drawer slide of claim 31, further comprising a first stopper attached to the bottom face in the second bottom race at an end of the support bar.

47. The drawer slide of claim 46, further comprising a second stopper attached to the bottom face in the first bottom race at an opposite end of the support bar from the first stopper.

48. The drawer slide of claim 31, further comprising a stopper attached to the second upper wall in the second upper race at an end of the second track portion.

49. The drawer slide of claim 31, further comprising a stopper attached to the second lower wall in the second lower race at an end of the second track portion.

50. The drawer slide of claim 31, further comprising an end stop attached to the first track portion in the first support bar channel.
